(19) United States
(12) Patent Application Publication
(10) Pub. No.: US 2026/0115704 A1
(43) Pub. Date: Apr. 30, 2026

(54) PREPARATION METHOD FOR AND USE OF MOLECULAR SIEVE-BASED HONEYCOMB MONOLITHIC DENITRIFICATION CATALYST

(71) Applicants: FuZhou University, Fujian (CN); Qingyuan Innovation Laboratory, Fujian (CN)

(72) Inventors: Yuanyuan Yue, Fujian (CN); Peng Jiang, Fujian (CN); Huangcong Deng, Fujian (CN); Peiyou Ma, Fujian (CN); Xueli Ge, Fujian (CN); Xiaojun Bao, Fujian (CN); Tiesen Li, Fujian (CN); Qingyan Cui, Fujian (CN); Jie Shi, Fujian (CN)

(73) Assignees: FuZhou University, Fujian (CN); Qingyuan Innovation Laboratory, Fujian (CN)

(21) Appl. No.: 19/373,629

(22) Filed: Oct. 29, 2025

(30) Foreign Application Priority Data
Oct. 30, 2024 (CN) 202411531015.0

(51) Int. Cl. B01J 29/46; B01D 53/86; B01J 21/16; B01J 29/76; B01J 29/85; B01J 35/57; B01J 37/00; B01J 37/02; B01J 37/04; B01J 37/08

(52) U.S. Cl. CPC B01J 29/46; B01D 53/8628; B01J 21/16; B01J 29/76; B01J 29/85; B01J 35/57; B01J 37/0018; B01J 37/0201; B01J 37/04; B01J 37/08; B01D 2251/2062; B01D 2255/20738; B01D 2255/20761; B01D 2255/504; B01D 2255/9155; B01D 2257/404

(57) ABSTRACT

Provided are a preparation method for and use of a molecular sieve-based honeycomb monolithic denitrification catalyst. A molecular sieve-based catalyst, a metal-modified natural silica-aluminum mineral, an organic binder, an extrusion aid, a pore-forming agent, glass fiber, a structuring agent, an inorganic binder, an acid solution, a humectant and water are mixed and then subjected to structuring water dissolution and other processes to obtain a molecular sieve-based honeycomb monolithic denitrification catalyst. According to the provided, a water-soluble polymer fiber bundle is used as a structuring agent to reduce the negative impact of carbon deposition poisoning on the molecular sieve catalyst, realize the through-connection of inner walls of honeycombs and create multi-channel inner walls based on a honeycomb body, thereby increasing the contact area and reaction contact time of a reaction gas with the molecular sieve catalyst embedded in the inner walls and the metal-modified natural structuring water dissolution mineral.

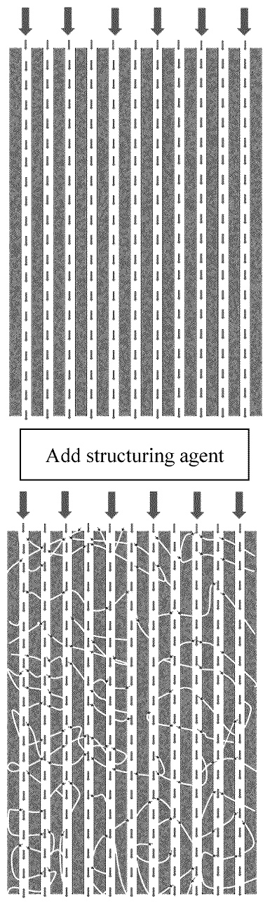

### CROSS-REFERENCE TO RELATED APPLICATION

This application claims the priority benefit of China application serial no. 202411531015.0, filed on Oct. 30, 2024. The entirety of the above-mentioned patent application is hereby incorporated by reference herein and made a part of this specification.

### TECHNICAL FIELD

The present invention belongs to the technical field of nitrogen oxide removal, and particularly relates to a preparation method for and use of a molecular sieve-based honeycomb monolithic denitrification catalyst.

### RELATED ART

Nitrogen oxides (NOx) are one of the main air pollutants and are extremely harmful to human beings, the environment and even social economy. Among the many denitrification technologies, NH₃—SCR (selective catalytic reduction with ammonia serving as a reducing agent) is the most mature and widely used.

The vanadium element in traditional vanadium-tungsten-titanium-based catalysts is biotoxic and environmentally harmful. Current regulations and standards impose more stringent requirements on denitrification catalysts, requiring use of novel catalysts that are efficient, pollution-free and safe to replace vanadium-based catalysts. Due to a special pore structure, adjustable acidity and excellent hydrothermal stability and other characteristics, molecular sieve-based catalysts have good catalytic activity in the removal of nitrogen oxides. Therefore, the molecular sieve-based catalysts have attracted widespread attention from researchers.

In actual denitrification applications, complex working conditions require that monolithic catalyst must have a certain mechanical strength while exerting the catalytic effect. Therefore, extruded monolithic denitrification catalysts are required to be used in industry.

As disclosed in U.S. Pat. Nos. 5,248,643 and 5,492,883, molecular sieve-based catalysts and related binders were used to prepare honeycomb monolithic catalysts by means of blending extrusion. However, the main bodies of the prepared monolithic catalysts were molecular sieves, and the preparation cost was high. Therefore, the prepared monolithic catalysts have not been used on a large scale in industry.

As disclosed in patent application No. CN106457144, inert supports were used to be combined with small-pore molecular sieve-based catalysts, and some binders were added to overcome poor formability to finally complete the extrusion molding of honeycomb catalysts. As disclosed in patent application No. WO178643, V₂O₅—WO₃/TiO₂ was blended with Fe-MFI and H-MOR molecular sieves for extrusion, and the results showed good catalytic activity. Similarly, patent application No. CN108273544 also confirmed that when Cu—Fe-based molecular sieves were blended with related aids for extrusion, the NOx conversion rate was greater than 80% at a temperature in a range of 200° C. to 550° C. The above technologies show that molecular sieve-based catalysts have good application prospects for denitrification reactions, but the molecular sieve-based catalysts still face some challenges in large-scale applications. First, molecular sieve-based catalysts have poor formability due to the inert nature; second, most supports are inert media relative to the reaction and cannot promote the reaction.

As disclosed in patent application No. CN115999525A, honeycomb catalyst supports were successfully prepared using natural minerals, binders and water. This technique is difficult to apply directly because of lack of catalytically active components. Patent application CN117839674A describes a method of modifying kaolin and introducing metal into a kaolin support by ion exchange to obtain a denitrification catalyst that is resistant to poisoning. However, due to complex process and production of a lot of industrial wastewater, the method is hardly industrially applied in large scale. Therefore, it is crucial to select a suitable catalyst support and modify the support with a metal.

Since an extruded honeycomb monolithic catalyst has straight-through wall characteristics, reaction gas flow stays for a short time and cannot form turbulence, cross-flow and the like. Since the residence time is short, it is difficult for a molecular sieve-based catalyst embedded in the inner walls to come into contact with reaction gas. Therefore, it is required to add a pore-forming agent for pore-enlarging treatment. Most studies provide use of organic media to form pores after calcination, and a large amount of pore-forming agents are added to form irregular particle pores to connect each other. Patent application No. CN108883356A provides use of a starch-based pore-forming agent to create pores to form intersecting pores of particles which are arranged in spherical piles. Patent application No. CN108727057A provides use of tapioca starch, corn straw powder, etc. as pore-forming agents to effectively widen pores and prepare silicon nitride ceramic supports. Patent application No. CN102861595A provides use of pulp, cotton, etc. as structural promoters to enhance the mechanical strength and porosity of monolithic catalysts. Such techniques face two challenges: First, the honeycombs are only subjected to porosity adjustment on the micro level, instead of structure adjustment on the macro level, and pores are spherical and irregularly piled, which produces certain turbulence on the gas flow. Second, carbon deposition occurs during the process of calcination and removal of a large amount of organic matter. For extruded monolithic catalysts, the catalytically active components embedded therein are prone to inactivation. Therefore, these techniques are only limited to the preparation of honeycomb supports. Therefore, for a molecular sieve-based honeycomb monolithic denitrification catalyst, an effective honeycomb structuring method is particularly important.

### SUMMARY OF INVENTION

An object of the present invention is to provide a preparation method for and use of a molecular sieve-based honeycomb monolithic denitrification catalyst, in order to solve the problem of incomplete reaction contact of a molecular sieve-based catalyst embedded in a honeycomb monolithic catalyst, and also solve the problem of poor formability due to the inert nature of the molecular sieve-based catalyst.

In order to achieve the above object, the present invention adopts the following technical solutions:

A preparation method for a molecular sieve-based honeycomb monolithic denitrification catalyst includes the following steps:
(1) mixing a molecular sieve-based catalyst and a metal-modified natural silica-aluminum mineral thoroughly, and then adding an organic binder, an extrusion aid, a pore-forming agent and glass fiber, and finally adding a structuring agent to obtain a mixed powder,
(2) adding an inorganic binder, an acid solution, a humectant and water into the mixed powder, mixing thoroughly, and then performing kneading, mud pugging, aging, pre-extrusion, extrusion molding, pre-drying, structuring water dissolution, drying and calcination to obtain a molecular sieve-based honeycomb monolithic denitrification catalyst.

Further, a molecular sieve contained in the molecular sieve-based catalyst is one of ZSM-5 molecular sieve, ZSM-35 molecular sieve, SSZ-13 molecular sieve, SSZ-39 molecular sieve, SAPO-11 molecular sieve, SAPO-34 molecular sieve, SAPO-47 molecular sieve, Y-type molecular sieve, Beta molecular sieve, KFI type molecular sieve and mordenite (MOR) or a combination thereof, and a molar ratio of silica to alumina in the molecular sieve is 2-300:1.

Further, a metal element contained in the molecular sieve-based catalyst is one of iron, copper, manganese, cerium, lanthanum, rhodium, ruthenium, palladium and osmium or a combination thereof, and the content of the metal element ranges from 0.1 wt % to 10.0 wt %.

Preferably, the molecular sieve-based catalyst is one of FeCu-ZSM-5 molecular sieve, FeCu—SSZ-13 molecular sieve, and FeCu-SAPO-34 molecular sieve or a combination thereof.

Further, a natural silica-aluminum mineral in the metal-modified natural silica-aluminum mineral is one of rectorite clay, kaolin, feldspar, nepheline, leucite, beryl, muscovite, pyrophyllite, kaolinite, rectorite, jadeite, spodumene, boehmite, perlite, phlogopite, vermiculite, montmorillonite, talc, serpentine, illite, palygorite, sepiolite, diatomite, attapulgite, enstatite, diopside, amphibole and olivine or a combination thereof, and the content of impurities (substances other than alumina and silica) in the natural silica-aluminum mineral is less than 20 wt %, and the particle size of the natural silica-aluminum mineral is not less than 200 mesh.

Further, a metal element in the metal-modified natural silica-aluminum mineral is one of iron, copper, manganese, cerium, lanthanum, rhodium, ruthenium, palladium, osmium and tungsten or a combination thereof, and the content of the metal is in a range of 0.1 wt % to 10.0 wt %. The introduction of the metal is done by loading nitrates or organic salts of the above metals on the natural silica-aluminum mineral by means of spraying or impregnation, drying at a temperature in a range of 50° C. to 100° C., and then crushing into powder with a required particle size of not less than 200 mesh, thus obtaining the metal-modified natural silica-aluminum mineral.

Further, the organic binder is one of sodium carboxymethyl cellulose, sodium polyacrylate, sodium hydroxypropyl cellulose, polyethylene glycol, polyethylene oxide and phenolic resin, or a combination thereof.

Further, the extrusion aid is one of starch, sesbania powder, ethanolamine and sodium stearate or a combination thereof.

Further, the main length distribution of the glass fiber ranges from 1.0 mm to 10.0 mm.

Further, the structuring agent is a water-soluble polymer fiber bundle, including one of water-soluble polyvinyl alcohol fiber, water-soluble seaweed fiber, and water-soluble carboxymethyl cellulose fiber or a combination thereof. The structuring agent is required to be in a bundle shape. Specifically, The structuring agent is required to have a length of 0.2 mm to 3.0 mm and a diameter of 10 μm to 1000 μm. The length is adjusted on the basis of the honeycomb wall thickness to directly penetrate the inner walls.

Further, the pore-forming agent is plant fiber particles, including one of straw, rice hull, sawdust, wood chips and bamboo chips or a combination thereof, and the particle size of the pore-forming agent is not less than 200 mesh.

Further, the inorganic binder is one of silica sol, water glass, pseudo-boehmite and aluminum sol or a combination thereof.

Further, the acid solution includes an organic acid solution and an inorganic acid solution, the organic acid includes one or more of citric acid, tartaric acid, malic acid, oxalic acid and lactic acid; the inorganic acid includes one or more of hydrochloric acid, nitric acid, sulfuric acid, phosphoric acid and boric acid. The concentration of an aqueous solution of the organic acid and the concentration of an aqueous solution of the inorganic acid are both in a range of 5 wt % to 20 wt %.

Further, the humectant is one of glycerol, tung oil and peanut oil or a combination thereof.

Further, the water is one of deionized water, pure water and mineral water or a combination thereof.

Further, a mass ratio of the raw materials is as follows: metal-modified natural silica-aluminum mineral: molecular sieve-based catalyst: organic binder: extrusion aid: glass fiber: structuring agent: pore-forming agent: inorganic binder: organic acid: inorganic acid: humectant: water=50-100:1-35:1-5:1-8:1-5:10-50:1-15:3-8:1-5:1-5:3-10:10-25.

Further, the kneading refers to stirring after the addition of all raw materials and the mixing time is in a range of 10 min to 60 min; the mud pugging is performed twice or three times; the aging is performed for one day to ten days; the pre-extrusion involves trial extrusion and mold lubrication after mold changing, and the pre-extrusion is performed for 5 min to 30 min; the extrusion molding is double screw extrusion which cooperates with molds of different shapes, and wall thickness is adjusted within a range of 0.5 mm to 3.0 mm; the pre-drying is performed to pre-remove moisture by 5 wt % of the mass of the materials; the drying is performed according to a temperature-humidity coordinated cross-control method, which means controlling the humidity and temperature curves to intersect and coordinating the drying process for dehydration; the calcination is performed in a muffle furnace under a closed condition according to a low-rate plateau heating method.

Further, the structuring water dissolution includes immersing the pre-dried material in water, and adjusting the temperature of water dissolution according to the dissolution temperature of the structuring agent, and the temperature of water dissolution ranges from 20° C. to 90° C. The time of the structuring water dissolution is required to be within a range of 0.5 h to 2.0 h, and finally water rinsing is performed twice or three times, with water temperature being in a range of 20° C. to 90° C.

Preferably, the drying is performed according to a temperature-humidity coordinated cross-control method, with temperature being controlled within a range of 25° C. to 100° C., and humidity being controlled within a range of 5% to 80%.

Preferably, during the drying process, first, the temperature and the humidity are controlled to be 25° C. and 80%, respectively; then, the temperature and the humidity are controlled to be 40° C. and 60%, respectively; then, the temperature and the humidity are controlled to be 60° C. and 40%, respectively; and then the temperature and the humidity are controlled to be 80° C. and 10%, respectively. This method can effectively control the drying rate and reduce the risk of cracking.

Preferably, the calcination is performed in a way of initiating calcination from an initial temperature of greater than 80° C. with the temperature increased at a low rate of 0.5° C./min to 2° C./min, and calcination temperature ranges from 80° C. to 800° C.

Preferably, during the calcination process, a plateau is set at a temperature in a range of 180° C. to 400° C. for calcination and binder removal, followed by further heating to a temperature ranging from 550° C. to 800° C. with a holding time of 6 h to 8 h for calcination.

Compared with the prior art, the present invention has the following beneficial effects:
1. It is crucial to select a suitable catalyst support and modify the support with a metal. The technology disclosed in the present invention uses an impregnation method to introduce relevant metal elements in one step to overcome complex process flows. The metal-modified natural silica-aluminum mineral not only serves as a catalyst support to support and strengthen the molecular sieve-based catalyst, but also interacts with the molecular sieve-based catalyst to promote the reaction.
2. For a molecular sieve-based honeycomb monolithic denitrification catalyst, an effective honeycomb structuring method is particularly important. According to the present invention, the honeycomb monolithic catalyst is structurally adjusted, and the water-soluble polymer fiber bundle and other structural agents are used to create regular through-channels to achieve the purpose of through inner walls, thereby increasing the time of reaction contact between a reaction gas and the molecular sieve-based catalyst embedded inside, and improving the efficiency of nitrogen oxide removal. The purpose of water solubility is to remove the structuring agent by dissolution in water and reduce the occurrence of carbon deposition and deactivation of the internal molecular sieve-based catalyst caused by organic matter during the high-temperature calcination stage. According to the present invention, the honeycomb monolithic denitrification catalyst is subjected to structural adjustment on the macro level to realize direct through-connection of inner walls of honeycombs; on the micro level, the metal-modified natural silica-aluminum mineral can interact with the molecular sieve-based catalyst to promote the denitrification reaction; during the production and preparation process, the natural silica-aluminum mineral plays a crucial role in the forming process and application.
3. The molecular sieve-based honeycomb monolithic denitrification catalyst prepared in the present invention has obvious advantages: since the present invention uses a molecular sieve-based catalyst to replace a biotoxic vanadium species, the monolithic denitrification catalyst of the present invention is more green and environmentally friendly as compared with traditional vanadium-based denitrification catalysts; moreover, the addition of the metal-modified molecular sieve-based catalyst can effectively improve the catalytic performance. Compared with inert supports, the metal-modified natural silica-aluminum minerals can not only improve catalytic activity, but also ensure fluidity during extrusion molding. After calcination and molding, the mechanical strength of the monolithic catalyst is improved by means of the sintering change process. In addition, the introduction of a water-soluble structuring agent can structurally adjust the inner walls of honeycombs, create regular through-channels and increase the reaction contact time while preventing the molecular sieve-based catalyst from deactivating due to carbon deposition.
4. During the denitrification reaction process, the metal-modified natural silica-aluminum mineral can interact with the molecular sieve-based catalyst. The prepared denitrification catalyst has high adhesion, high adsorption and high reactivity, can effectively overcome the defect of inert nature of the molecular sieve-based catalyst and significantly improve extrusion fluidity as well as the mechanical strength after molding. The method of the present invention is simple in preparation process with low production cost and can be put into large-scale production easily, thus having good industrial application prospects.

### BRIEF DESCRIPTION OF DRAWINGS

FIGURE shows cross-sections of honeycombs before and after structuring; left: before structuring; right: after structuring.

### DESCRIPTION OF EMBODIMENTS

The invention will be further explained below in conjunction with specific examples, which are intended to illustrate the embodiments and features of the invention in detail and should not be construed as any limitation on the invention.

As shown in FIGURE, the present invention adjusts the honeycomb structure, and the addition of a water-soluble structuring agent not only reduces the carbon deposition poisoning of the molecular sieve-based catalyst, but also achieves regular through-pore structure in the inner walls and increases the time of contact with the internal catalyst, thus improving the catalytic efficiency.

FeCu-ZSM-5, FeCu—SSZ-13, and FeCu-SAPO-34 molecular sieves in the examples are high-performance denitrification molecular sieves synthesized in situ by a one-pot method and belong to bimetallic molecular sieve-based catalysts. The introduction of Cu can not only regulate the acidity of the framework Fe³⁺ and the molecular sieve, but also improve the redox capacity. Molecular sieve-based catalysts with isolated Cu²⁺, a relatively high content of framework Fe³⁺, good redox performance and acidity have good catalytic activity for denitrification.

The natural silica-aluminum mineral used in the examples is natural rectorite clay (purchased from Hubei Mingliu Rectorite Clay Co., Ltd., with a particle size of less than 200 mesh). In the natural rectorite clay, the content of SiO₂ is 43.2%, and the content of Al₂O₃ is 37.2%.

The natural silica-aluminum mineral kaolin used in the examples was purchased from China Kaolin Clay Co., Ltd., with a particle size of less than 300 mesh). In the natural kaolin, the content of SiO₂ is 48.0%, and the content of Al₂O₃ is 37.0%.

### Example 1

A preparation method for a molecular sieve-based honeycomb monolithic denitrification catalyst for nitrogen oxide removal includes the following steps:

The following raw materials were weighed in parts by mass: 45 parts of natural silica-aluminum mineral rectorite clay, 40 parts of FeCu-ZSM-5 molecular sieve, 3 parts of sodium carboxymethyl cellulose, 5 parts of sesbania powder, 1 part of glass fiber with a length-diameter ratio of 2-4:1, 20 parts of water-soluble polyvinyl alcohol fiber bundles, 10 parts of wood chips, 7 parts of silica sol, 1 part of lactic acid, 1 part of nitric acid, 10 parts of glycerol, and 25 parts of deionized water.

Before the materials were mixed, 45 parts of natural silica-aluminum mineral rectorite clay were metal-modified firstly. The specific process is as follows:

3 parts of manganese nitrate solution (1 mol/L) were sprayed to impregnate 45 parts of natural silica-aluminum mineral rectorite clay with stirring. After drying and crushing, the total mass of the material was increased by about 1 wt % to 2 wt %.
(1) The metal-modified natural silica-aluminum mineral rectorite clay and FeCu-ZSM-5 molecular sieve were mixed thoroughly in a mixer.
(2) Then, sodium carboxymethyl cellulose, sesbania powder, glass fiber, and wood chips were added into the mixer and the materials were then mixed thoroughly to obtain a homogeneous dry material.
(3) Water-soluble polyvinyl alcohol bundles were added and the materials were then mixed thoroughly.
(4) Then, silica sol, lactic acid, nitric acid, glycerol and deionized water were added for kneading.
(5) The mud kneaded in step (4) was repeatedly pugged for three times.
(6) The mud from step (5) was sealed with plastic wrap, and placed in a dry and cool place for aging for 48 h.
(7) The mud pugged in step (6) was fed into a forming machine for extrusion molding.
(8) The formed honeycombs were pre-dried to remove moisture by 5 wt % of the total mass, and then placed into 60° C. water to remove the water-soluble polyvinyl alcohol fiber bundles. After being immersed for 10 h, the honeycombs were taken out and rinsed with 60° C. water for three times to obtain Material A.
(9) Material A was dried, and the drying curve was as follows: the material was dried at a temperature of 30° C., a humidity of 70% for 10 h; then, dried at a temperature of 50° C., a humidity of 60% for 5 h; and then dried at a temperature of 70° C., humidity of 30% for 3 h; and finally the material was transferred to a common oven to be dried at 100° C. for 3 h to obtain Material B.
(10) Material B was placed in a muffle furnace for calcination, and the calcining curve was as follows: calcination was initiated at 100° C., with the temperature increased at a rate of 0.5° C./min; when the temperature reached 200° C., the temperature was held for 2 h for binder removal; then, the material was further heated to 400° C. with a holding time of 2 h; and then the material was heated to 600° C. with a holding time of 8 h. Finally, a molecular sieve-based honeycomb monolithic denitrification catalyst was obtained.
(11) The prepared molecular sieve-based honeycomb monolithic denitrification catalyst was placed into a monolithic catalyst evaluation device, in which sample evaluation was conducted using simulated flue gas components including N₂, CO₂, NH₃, NO, and O₂, and the reaction conditions were maintained as follows: space velocity of 5000 h⁻¹, [NO]=[NH₃]=500 ppm, [O₂]=5%, and H₂O=5%. The NO concentrations at an inlet and an outlet were detected separately to calculate the denitrification efficiency of the catalyst. The evaluation results are shown in Table 1.

### Example 2

A preparation method for a molecular sieve-based honeycomb monolithic denitrification catalyst for nitrogen oxide removal includes the following steps:

The following raw materials were weighed in parts by mass: 50 parts of natural silica-aluminum mineral kaolin, 35 parts of FeCu-ZSM-5 molecular sieve, 3 parts of sodium carboxymethyl cellulose, 5 parts of sesbania powder, 1 part of glass fiber with a length-diameter ratio of 2-4:1, 25 parts of water-soluble polyvinyl alcohol fiber bundles, 10 parts of rice hull powder, 4 parts of silica sol, 1 part of oxalic acid, 1 part of nitric acid, 5 parts of tung oil, and 16 parts of deionized water.

Before the materials were mixed, 50 parts of natural silica-aluminum mineral kaolin were metal-modified firstly. The specific process is as follows:

3 parts of manganese nitrate solution (1 mol/L) were sprayed and loaded onto 50 parts of natural silica-aluminum mineral kaolin with stirring. After drying and crushing, the total mass of the material was increased by about 1 wt % to 2 wt %.
(1) The metal-modified natural silica-aluminum mineral kaolin and FeCu-ZSM-5 molecular sieve were mixed thoroughly in a mixer.
(2) Then, sodium carboxymethyl cellulose, sesbania powder, glass fiber, and rice hull powder were added into the mixer and the materials were then mixed thoroughly to obtain a homogeneous dry material.
(3) Water-soluble polyvinyl alcohol bundles were added and the materials were then mixed thoroughly.
(4) Then, silica sol, oxalic acid, nitric acid, tung oil and deionized water were added for kneading.
(5) The mud kneaded in step (4) was repeatedly pugged twice.
(6) The mud from step (5) was sealed with plastic wrap, and placed in a dry and cool place for aging for 48 h.
(7) The mud pugged in step (6) was fed into a forming machine for extrusion molding.
(8) The formed honeycombs were pre-dried to remove moisture by 5 wt %, and then placed into 60° C. water to remove the water-soluble polyvinyl alcohol fiber bundles. After being immersed for 10 h, the honeycombs were taken out and rinsed with 60° C. water for three times to obtain Material A.
(9) Material A was dried, and the drying curve was as follows: the material was dried at a temperature of 30° C., a humidity of 60% for 10 h; then, dried at a temperature of 50° C., a humidity of 60% for 5 h; and then dried at a temperature of 70° C., humidity of 30% for 3 h; and finally the material was transferred to a common oven to be dried at 100° C. for 3 h to obtain Material B.
(10) Material B was placed in a muffle furnace for calcination, and the calcining curve was as follows: calcination was initiated at 100° C., with the temperature increased at a rate of 0.5° C./min; when the temperature reached 200° C., the temperature was held for 2 h for binder removal; then, the material was further heated to 400° C. with a holding time of 2 h; and then the material was heated to 600° C. with a holding time of 8 h. Finally, a molecular sieve-based honeycomb monolithic denitrification catalyst was obtained.
(11) The prepared molecular sieve-based honeycomb monolithic denitrification catalyst was placed into a monolithic catalyst evaluation device, in which sample evaluation was conducted using simulated flue gas components including N₂, NH₃, H₂O, NO, and O₂, and the reaction conditions were maintained as follows: space velocity of 5000 h⁻¹, [NO]=[NH₃]=500 ppm, [O_{2]=}5%, and H₂O=5%. The NO concentrations at an inlet and an outlet were detected separately to calculate the denitrification efficiency of the catalyst. The evaluation results are shown in Table 1.

### Example 3

A preparation method for a molecular sieve-based honeycomb monolithic denitrification catalyst for nitrogen oxide removal includes the following steps:

The following raw materials were weighed in parts by mass: 55 parts of natural silica-aluminum mineral rectorite clay, 30 parts of FeCu—SSZ-13 molecular sieve, 3 parts of sodium carboxymethyl cellulose, 8 parts of sesbania powder, 1 part of glass fiber with a length-diameter ratio of 2-4:1, 25 parts of water-soluble polyvinyl alcohol fiber bundles, 10 parts of straw powder, 4 parts of pseudo-boehmite, 1 part of malic acid, 1 part of nitric acid, 7 parts of glycerol, and 17 parts of deionized water.

Before the materials were mixed, 55 parts of natural silica-aluminum mineral rectorite clay were metal-modified firstly. The specific process is as follows:

3 parts of manganese nitrate solution (1 mol/L) were sprayed and loaded onto 55 parts of natural silica-aluminum mineral rectorite clay with stirring. After drying and crushing, the total mass of the material was increased by about 1 wt % to 2 wt %.
(1) The natural silica-aluminum mineral rectorite clay and FeCu—SSZ-13 molecular sieve were mixed thoroughly in a mixer.
(2) Then, sodium carboxymethyl cellulose, sesbania powder, glass fiber, and straw powder were added into the mixer and the materials were then mixed thoroughly to obtain a homogeneous dry material.
(3) Water-soluble polyvinyl alcohol bundles were added and the materials were then mixed thoroughly.
(4) Then, pseudo-boehmite, malic acid, nitric acid, glycerol and deionized water were added for kneading.
(5) The mud kneaded in step (4) was repeatedly pugged twice.
(6) The mud from step (5) was sealed with plastic wrap, and placed in a dry and cool place for aging for 24 h.
(7) The mud pugged in step (6) was fed into a forming machine for extrusion molding.
(8) The formed honeycombs were pre-dried to remove moisture by 5 wt %, and then placed into 60° C. water to remove the water-soluble polyvinyl alcohol fiber bundles. After being immersed for 10 h, the honeycombs were taken out and rinsed with 60° C. water for three times to obtain Material A.
(9) Material A was dried, and the drying curve was as follows: the material was dried at a temperature of 30° C., a humidity of 80% for 10 h; then at a temperature of 40° C., a humidity of 70% for 5 h; and then at a temperature of 70° C., humidity of 30% for 3 h; and finally the material was transferred to a common oven to be dried at 100° C. for 3 h to obtain material B.
(10) Material B was placed in a muffle furnace for calcination, and the calcining curve was as follows: calcination was initiated at 100° C., with the temperature increased at a rate of 0.5° C./min; when the temperature reached 170° C., the temperature was held for 2 h for binder removal; then, the material was further heated to 350° C. with a holding time of 2 h; and then the material was heated to 550° C. with a holding time of 8 h. Finally, a molecular sieve-based honeycomb monolithic denitrification catalyst was obtained.
(11) The prepared novel molecular sieve-based honeycomb monolithic denitrification catalyst was placed into a monolithic catalyst evaluation device, in which sample evaluation was conducted using simulated flue gas components including N₂, NH₃, H₂O, NO, and O₂, and the reaction conditions were maintained as follows: space velocity of 5000 h⁻¹, [NO]=[NH₃]=500 ppm, [O₂]=5%, and H₂O=5%. The NO concentrations at an inlet and an outlet were detected separately to calculate the denitrification efficiency of the catalyst. The evaluation results are shown in Table 1.

### Example 4

A preparation method for a molecular sieve-based honeycomb monolithic denitrification catalyst for nitrogen oxide removal includes the following steps:

The following raw materials were weighed in parts by mass: 60 parts of natural silica-aluminum mineral kaolin, 25 parts of FeCu-ZSM-5 molecular sieve, 3 parts of sodium carboxymethyl cellulose, 5 parts of sesbania powder, 1 part of glass fiber with a length-diameter ratio of 2-4:1, 25 parts of water-soluble polyvinyl alcohol fiber bundles, 10 parts of sawdust, 4 parts of silica sol, 1 part of lactic acid, 1 part of nitric acid, 5 parts of glycerol, and 14 parts of deionized water.

Before the materials were mixed, 60 parts of natural silica-aluminum mineral kaolin were metal-modified firstly. The specific process is as follows:

3 parts of molybdenum nitrate solution (1 mol/L) were sprayed and loaded onto 60 parts of natural silica-aluminum mineral kaolin with stirring. After drying and crushing, the total mass of the material was increased by about 1 wt % to 2 wt %.
(1) The metal-modified natural silica-aluminum mineral kaolin and FeCu-ZSM-5 molecular sieve were mixed thoroughly in a mixer.
(2) Then, sodium carboxymethyl cellulose, sesbania powder, glass fiber, and sawdust were added into the mixer and the materials were then mixed thoroughly to obtain a homogeneous dry material.
(3) Water-soluble polyvinyl alcohol bundles were added and the materials were then mixed thoroughly.
(4) Then, silica sol, lactic acid, nitric acid, glycerol and deionized water were added for kneading.
(5) The mud kneaded in step (4) was repeatedly pugged twice.
(6) The mud from step (5) was sealed with plastic wrap, and placed in a dry and cool place for aging for 48 h.
(7) The mud pugged in step (6) was fed into a forming machine for extrusion molding.
(8) The formed honeycombs were pre-dried to remove moisture by 5 wt %, and then placed in 50° C. water bath to remove the water-soluble polyvinyl alcohol fiber bundles. After being immersed for 10 h, the honeycombs were taken out and rinsed with 60° C. water for three times to obtain Material A.
(9) Material A was dried, and the drying curve was as follows: the material was dried at a temperature of 30° C., a humidity of 80% for 10 h; then, dried at a temperature of 50° C., a humidity of 60% for 5 h; and then dried at a temperature of 70° C., humidity of 30% for 3 h; and finally the material was transferred to an oven to be dried at 100° C. for 3 h to obtain Material B.
(10) Material B was placed in a muffle furnace for calcination, and the calcining curve was as follows: calcination was initiated at 100° C., with the temperature increased at a rate of 0.5° C./min; when the temperature reached 230° C., the temperature was held for 2 h for binder removal; then, the material was further heated to 420° C. with a holding time of 2 h; and then the material was heated to 650° C. with a holding time of 8 h. Finally, a molecular sieve-based honeycomb monolithic denitrification catalyst was obtained.
(11) The prepared novel molecular sieve-based honeycomb monolithic denitrification catalyst was placed into a monolithic catalyst evaluation device, in which sample evaluation was conducted using simulated flue gas components including N₂, NH₃, H₂O, NO, and O₂, and the reaction conditions were maintained as follows: space velocity of 5000 h⁻¹, [NO]=[NH₃]=500 ppm, [O₂]=5%, and H₂O=5%. The NO concentrations at an inlet and an outlet were detected separately to calculate the denitrification efficiency of the catalyst. The evaluation results are shown in Table 1.

### Example 5

A preparation method for a molecular sieve-based honeycomb monolithic denitrification catalyst for nitrogen oxide removal includes the following steps:

The following raw materials were weighed in parts by mass: 70 parts of natural silica-aluminum mineral kaolin, 15 parts of FeCu—SSZ-13 molecular sieve, 3 parts of sodium carboxymethyl cellulose, 7 parts of sesbania powder, 1 part of glass fiber with a length-diameter ratio of 2-4:1, 25 parts of water-soluble polyvinyl alcohol fiber bundles, 10 parts of bamboo chips, 5 parts of aluminum sol, 2 part of citric acid, 1 part of boric acid, 7 parts of glycerol, and 18 parts of deionized water.

Before the materials were mixed, 70 parts of natural silica-aluminum mineral kaolin were metal-modified firstly. The specific process is as follows:

5 parts of molybdenum nitrate solution (1 mol/L) were sprayed and loaded onto 70 parts of natural silica-aluminum mineral kaolin with stirring. After drying and crushing, the total mass of the material was increased by about 1 wt % to 2 wt %.
(1) The metal-modified natural silica-aluminum mineral kaolin and FeCu-ZSM-5 molecular sieve were mixed thoroughly in a mixer.
(2) Then, sodium carboxymethyl cellulose, sesbania powder, glass fiber, and bamboo chips were added into the mixer and the materials were then mixed to obtain a homogeneous dry material.
(3) Water-soluble polyvinyl alcohol bundles were added and the materials were then mixed thoroughly.
(4) Then, aluminum sol, citric acid, boric acid, glycerol and deionized water were added for kneading.
(5) The mud kneaded in step (4) was repeatedly pugged for three times.
(6) The mud from step (5) was sealed with plastic wrap, and placed in a dry and cool place for aging for 24 h.
(7) The mud pugged in step (6) was fed into a forming machine for extrusion molding.
(8) The formed honeycombs were pre-dried to remove moisture by 5 wt %, and then placed into 60° C. water to remove the water-soluble polyvinyl alcohol fiber bundles. After being immersed for 10 h, the honeycombs were taken out and rinsed with 60° C. water for three times to obtain Material A.
(9) Material A was dried, and the drying curve was as follows: the material was dried at a temperature of 25° C., a humidity of 70% for 8 h; then, dried at a temperature of 45° C., a humidity of 50% for 8 h; and then dried at a temperature of 70° C., humidity of 30% for 4 h; and finally the material was transferred to a common oven to be dried at 100° C. for 2 h to obtain Material B.
(10) Material B was placed in a muffle furnace for calcination, and the calcining curve was as follows: calcination was initiated at 100° C., with the temperature increased at a rate of 1.0° C./min; when the temperature reached 180° C., the temperature was held for 2 h for binder removal; then, the material was further heated to 370° C. with a holding time of 2 h; and then the material was heated to 550° C. with a holding time of 8 h. Finally, a molecular sieve-based honeycomb monolithic denitrification catalyst was obtained.
(11) The prepared novel molecular sieve-based honeycomb monolithic catalyst was placed into a monolithic catalyst evaluation device, in which sample evaluation was conducted using simulated flue gas components including N₂, NH₃, H₂O, NO, and O₂, and the reaction conditions were maintained as follows: space velocity of 5000 h⁻¹, [NO]=[NH₃]=500 ppm, [O₂]=5%, and H₂O=5%. The NO concentrations at an inlet and an outlet were detected separately to calculate the denitrification efficiency of the catalyst. The evaluation results are shown in Table 1.

### Example 6

A preparation method for a molecular sieve-based honeycomb monolithic catalyst for nitrogen oxide removal includes the following steps:

The following raw materials were weighed in parts by mass: 75 parts of natural silica-aluminum mineral kaolin, 10 parts of FeCu-SAPO-34 molecular sieve, 3 parts of sodium carboxymethyl cellulose, 5 parts of sesbania powder, 1 part of glass fiber with a length-diameter ratio of 2-4:1, 30 parts of water-soluble polyvinyl alcohol fiber bundles, 10 parts of wood chips, 4 parts of silica sol, 1 part of lactic acid, 1 part of nitric acid, 5 parts of glycerol, and 16 parts of deionized water.

Before the materials were mixed, 75 parts of natural silica-aluminum mineral kaolin were metal-modified firstly. The specific process is as follows:

5 parts of manganese nitrate solution (1 mol/L) were sprayed and loaded onto 75 parts of natural silica-aluminum mineral kaolin with stirring. After drying and crushing, the total mass of the material was increased by about 1 wt % to 2 wt %.
(1) The metal-modified natural silica-aluminum mineral kaolin and FeCu-ZSM-5 molecular sieve were mixed thoroughly in a mixer.
(2) Then, sodium carboxymethyl cellulose, sesbania powder, glass fiber, and wood chips were added into the mixer and the materials were then mixed thoroughly to obtain a homogeneous dry material.
(3) Water-soluble polyvinyl alcohol bundles were added and the materials were then mixed thoroughly.
(4) Then, silica sol, lactic acid, nitric acid, glycerol and deionized water were added for kneading.
(5) The mud kneaded in step (4) was repeatedly pugged for three times.
(6) The mud from step (5) was sealed with plastic wrap, and placed in a dry and cool place for aging for 48 h.
(7) The mud pugged in step (6) was fed into a forming machine for extrusion molding.
(8) The formed honeycombs were pre-dried to remove moisture by 5 wt %, and then placed into 60° C. water to remove the water-soluble polyvinyl alcohol fiber bundles. After being immersed for 10 h, the honeycombs were taken out and rinsed with 60° C. water for three times to obtain Material A.
(9) Material A was dried, and the drying curve was as follows: the material was dried at a temperature of 30° C., a humidity of 80% for 10 h; then, dried at a temperature of 50° C., a humidity of 60% for 5 h; and then dried at a temperature of 70° C., humidity of 30% for 3 h; and finally the material was transferred to a common oven to be dried at 100° C. for 3 h to obtain Material B.
(10) Material B was placed in a muffle furnace for calcination, and the calcining curve was as follows: calcination was initiated at 100° C., with the temperature increased at a rate of 0.5° C./min; when the temperature reached 200° C., the temperature was held for 2 h for binder removal; then, the material was further heated to 400° C. with a holding time of 2 h; and then the material was heated to 600° C. with a holding time of 8 h. Finally, a molecular sieve-based honeycomb monolithic denitrification catalyst was obtained.
(11) The prepared novel molecular sieve-based honeycomb monolithic denitrification catalyst was placed into a monolithic catalyst evaluation device, in which sample evaluation was conducted using simulated flue gas components including N₂, NH₃, H₂O, NO, and O₂, and the reaction conditions were maintained as follows: space velocity of 5000 h⁻¹, [NO]=[NH₃]=500 ppm, [O₂]=5%, and H₂O=5%. The NO concentrations at an inlet and an outlet were detected separately to calculate the denitrification efficiency of the catalyst. The evaluation results are shown in Table 1.

### Example 7

A preparation method for a molecular sieve-based honeycomb monolithic denitrification catalyst for nitrogen oxide removal includes the following steps:

The following raw materials were weighed in parts by mass: 80 parts of natural silica-aluminum mineral kaolin, 15 parts of FeCu-SAPO-34 molecular sieve, 3 parts of sodium carboxymethyl cellulose, 5 parts of sesbania powder, 1 part of glass fiber with a length-diameter ratio of 2-4:1, 30 parts of water-soluble polyvinyl alcohol fiber bundles, 10 parts of wood chips, 4 parts of silica sol, 1 part of citric acid, 0.5 part of sulfuric acid, 5 parts of glycerol, and 14 parts of deionized water.

Before the materials were mixed, 80 parts of natural silica-aluminum mineral kaolin were metal-modified firstly. The specific process is as follows:

5 parts of manganese nitrate solution (1 mol/L) were sprayed and loaded onto 80 parts of natural silica-aluminum mineral kaolin with stirring. After drying and crushing, the total mass of the material was increased by about 1 wt % to 2 wt %.
(1) The metal-modified natural silica-aluminum mineral kaolin and FeCu-ZSM-5 molecular sieve were mixed thoroughly in a mixer.
(2) Then, sodium carboxymethyl cellulose, sesbania powder, glass fiber, and wood chips were added into the mixer and the materials were then mixed to obtain a homogeneous dry material.
(3) Water-soluble polyvinyl alcohol bundles were added and the materials were then mixed thoroughly.
(4) Then, silica sol, lactic acid, nitric acid, glycerol and deionized water were added for kneading.
(5) The mud kneaded in step (4) was repeatedly pugged twice or three times.
(6) The mud from step (5) was sealed with plastic wrap, and placed in a dry and cool place for aging for 48 h.
(7) The mud pugged in step (6) was fed into a forming machine for extrusion molding.
(8) The formed honeycombs were pre-dried to remove moisture by 5 wt %, and then placed in 60° C. water bath to remove the water-soluble polyvinyl alcohol fiber bundles. After being immersed for 10 h, the honeycombs were taken out and rinsed with 60° C. water for three times to obtain Material A.
(9) Material A was dried, and the drying curve was as follows: the material was dried at a temperature of 30° C., a humidity of 80% for 10 h; then, dried at a temperature of 50° C., a humidity of 60% for 5 h; and then dried at a temperature of 70° C., humidity of 30% for 3 h; and finally the material was transferred to a common oven to be dried at 100° C. for 3 h to obtain Material B.
(10) Material B was placed in a muffle furnace for calcination, and the calcining curve was as follows: calcination was initiated at 100° C., with the temperature increased at a rate of 0.5° C./min; when the temperature reached 250° C., the temperature was held for 2 h for binder removal; then, the material was further heated to 450° C. with a holding time of 2 h; and then the material was heated to 700° C. with a holding time of 8 h. Finally, a molecular sieve-based honeycomb monolithic denitrification catalyst was obtained.
(11) The prepared novel molecular sieve-based honeycomb monolithic denitrification catalyst was placed into a monolithic catalyst evaluation device, in which sample evaluation was conducted using simulated flue gas components including N₂, NH₃, H₂O, NO, and O₂, and the reaction conditions were maintained as follows: space velocity of 5000 h⁻¹, [NO]=[NH₃]=500 ppm, [O₂]=5%, and H₂O=5%. The NO concentrations at an inlet and an outlet were detected separately to calculate the denitrification efficiency of the catalyst. The evaluation results are shown in Table 1.

The evaluation results of the denitrification reactions in Examples 1 to 7 are shown in Table 1.

TABLE 1
Evaluation results of denitrification reactions

| | Molecular sieve-based catalyst | |
|---|---|---|
| Test item | NOₓ conversion rate ≥80% | |
| Example 1 | 248.8.8-589.5° | C. |
| Example 2 | 252.2-605.4° | C. |
| Example 3 | 210.3-580.3° | C. |
| Example 4 | 271.6-595.4° | C. |
| Example 5 | 230.8-564.9° | C. |
| Example 6 | 305.4-589.5° | C. |
| Example 7 | 291.7-526.4° | C. |

After experimental demonstration, according to the present invention, a suitable natural silica-aluminum mineral support is selected, which overcomes the challenge that pure molecular sieve-based catalysts are difficult to form. The use of the natural silica-aluminum mineral support improves fluidity during the extrusion process and enhances mechanical strength after calcination. Moreover, the metal-modified natural silica-aluminum mineral support can provide a certain degree of catalytic activity. According to the present invention, the honeycomb body is structurally adjusted. The water-soluble polymer fiber bundle effectively produces a regular through structure for inner walls to expose the molecular sieve-based catalyst embedded inside. Moreover thanks to the water solubility of the water-soluble polymer fiber bundle, the molecular sieve-based catalyst is protected from carbon deposition poisoning. According to the present invention, a honeycomb monolithic catalyst with internal through-pores is prepared using a molecular sieve-based catalyst as the main active component. Compared with traditional commercial V-based honeycomb monolithic catalysts, the catalyst of the present invention implements the concept of green environmental protection, and has practical application value.

What is claimed is:

1. A preparation method for a molecular sieve-based honeycomb monolithic denitrification catalyst, comprising the following steps:
(1) mixing a molecular sieve-based catalyst and a metal-modified natural silica-aluminum mineral thoroughly, and then adding an organic binder, an extrusion aid, a pore-forming agent and glass fiber, and finally adding a structuring agent to obtain a mixed powder,
wherein a metal element in the metal-modified natural silica-aluminum mineral is one of iron, copper, manganese, cerium, lanthanum, rhodium, ruthenium, palladium, osmium and tungsten or a combination thereof, and a content of the metal is in a range of 0.1 wt % to 10.0 wt %, and an introduction of the metal is done by loading nitrates or organic salts of the above metals on the natural silica-aluminum mineral by means of spraying or impregnation;
the structuring agent is a water-soluble polymer fiber bundle; and
(2) adding an inorganic binder, an acid solution, a humectant and water into the mixed powder, mixing thoroughly, and then performing kneading, mud pugging, aging, pre-extrusion, extrusion molding, pre-drying, structuring water dissolution, drying and calcination to obtain the molecular sieve-based honeycomb monolithic denitrification catalyst,
wherein the structuring water dissolution comprises immersing a pre-dried material in water with a temperature of 20° C. to 90° C. for 0.5 h to 2.0 h, and then rinsing with water with a temperature of 20° C. to 90° C. twice or three times.

2. The preparation method for a molecular sieve-based honeycomb monolithic denitrification catalyst according to claim 1, wherein a molecular sieve contained in the molecular sieve-based catalyst is one of ZSM-5 molecular sieve, ZSM-35 molecular sieve, SSZ-13 molecular sieve, SSZ-39 molecular sieve, SAPO-11 molecular sieve, SAPO-34 molecular sieve, SAPO-47 molecular sieve, Y-type molecular sieve, Beta molecular sieve, KFI type molecular sieve and mordenite or a combination thereof, and a molar ratio of silica to alumina in the molecular sieve is 2-300:1; a metal element contained in the molecular sieve-based catalyst is one of iron, copper, manganese, cerium, lanthanum, rhodium, ruthenium, palladium and osmium or a combination thereof, and a content of the metal element ranges from 0.1 wt % to 10.0 wt %.

3. The preparation method for a molecular sieve-based honeycomb monolithic denitrification catalyst according to claim 2, wherein the molecular sieve-based catalyst is one of FeCu-ZSM-5 molecular sieve, FeCu—SSZ-13 molecular sieve, and FeCu-SAPO-34 molecular sieve or a combination thereof.

4. The preparation method for a molecular sieve-based honeycomb monolithic denitrification catalyst according to claim 1, wherein the water-soluble polymer fiber bundle is one of polyvinyl alcohol fiber, seaweed fiber, and carboxymethyl cellulose fiber or a combination thereof.

5. The preparation method for a molecular sieve-based honeycomb monolithic denitrification catalyst according to claim 1, wherein a natural silica-aluminum mineral in the metal-modified natural silica-aluminum mineral is one of rectorite clay, kaolin, feldspar, nepheline, leucite, beryl, muscovite, pyrophyllite, kaolinite, rectorite, jadeite, spodumene, boehmite, perlite, phlogopite, vermiculite, montmorillonite, talc, serpentine, illite, palygorite, sepiolite, diatomite, attapulgite, enstatite, diopside, amphibole and olivine or a combination thereof, and a content of impurities in the natural silica-aluminum mineral is less than 20 wt %, and a particle size of the natural silica-aluminum mineral is not less than 200 mesh;
the organic binder is one of sodium carboxymethyl cellulose, sodium polyacrylate, sodium hydroxypropyl cellulose, polyethylene glycol, polyethylene oxide and phenolic resin, or a combination thereof;
the extrusion aid is one of starch, sesbania powder, ethanolamine and sodium stearate or a combination thereof;
the pore-forming agent is plant fiber particles and the plant fiber is one of straw, rice hull, sawdust, wood chips and bamboo chips or a combination thereof;
the inorganic binder is one of silica sol, water glass, pseudo-boehmite and aluminum sol or a combination thereof;
the humectant is one of glycerol, tung oil and peanut oil or a combination thereof.

6. The preparation method for a molecular sieve-based honeycomb monolithic denitrification catalyst according to claim 1, wherein the acid solution comprises an organic acid solution and an inorganic acid solution; the organic acid comprises one or more of citric acid, tartaric acid, malic acid, oxalic acid and lactic acid; the inorganic acid includes one or more of hydrochloric acid, nitric acid, sulfuric acid, phosphoric acid and boric acid; a concentration of an aqueous solution of the organic acid and a concentration of an aqueous solution of the inorganic acid are both in a range of 5 wt % to 20 wt %.

7. The preparation method for a molecular sieve-based honeycomb monolithic denitrification catalyst according to claim 6, wherein a mass ratio of the raw materials is as follows: the metal-modified natural silica-aluminum mineral: the molecular sieve-based catalyst: the organic binder: the extrusion aid: the glass fiber: the structuring agent: the pore-forming agent: the inorganic binder: the organic acid: the inorganic acid: the humectant: the water=50-100:1-35:1-5:1-8:1-5:10-50:1-15:3-8:1-5:1-5:3-10:10-25.

8. The preparation method for a molecular sieve-based honeycomb monolithic denitrification catalyst according to claim 1, wherein the kneading refers to stirring after addition of all raw materials and a mixing time is in a range of 10 min to 60 min;
the mud pugging is performed twice or three times;
the aging is performed for one day to ten days;
the extrusion molding is double screw extrusion which cooperates with molds of different shapes, and wall thickness is adjusted within a range of 0.5 mm to 3.0 mm;
the pre-drying is performed to pre-remove moisture by 5 wt % of a mass of the material obtained after extrusion molding;
the drying is performed according to a temperature-humidity coordinated cross-control method, which means controlling the humidity and temperature curves to intersect and coordinating the drying process for dehydration;
the calcination is performed in a muffle furnace under a closed condition according to a low-rate plateau heating method.

9. The preparation method for a molecular sieve-based honeycomb monolithic denitrification catalyst according to claim 1, wherein the drying is performed according to a temperature-humidity coordinated cross-control method, with temperature being controlled within a range of 25° C. to 100° C., and humidity being controlled within a range of 5% to 80%;
the calcination is performed in a way of initiating calcination from a temperature of greater than 80° C. with temperature increased at a low rate of 0.5° C./min to 2° C./min, and when the temperature reaches a temperature ranging from 180° C. to 400° C., holding the temperature for 2 h for calcination and binder removal, and then further heating to a temperature ranging from 550° C. to 800° C. with a holding time of 6 h to 8 h for calcination.

10. A use of a molecular sieve-based honeycomb monolithic denitrification catalyst prepared by the method according to claim 1 in NH₃—SCR.
